(19) United States
(12) Patent Application Publication
(10) Pub. No.: US 2008/0135472 A1
(43) Pub. Date: Jun. 12, 2008

(54) Trickling Filter Wastewater Treatment Device

(76) Inventor: Kevin R. Chaffee, Batesville, IN (US)

Correspondence Address: BAKER & DANIELS LLP, 300 NORTH MERIDIAN STREET, SUITE 2700, INDIANAPOLIS, IN, 46204, US

(21) Appl. No.: 11/660,535

(22) PCT Filed: Aug. 17, 2005
(86) PCT No.: PCT/US05/29249

§ 371 Date: Feb. 16, 2007

Related U.S. Application Data
(60) Provisional application No. 60/602,963, filed on Aug. 19, 2004.

(51) Int. Cl. B01D 24/02

(52) U.S. Cl. 210/505

(57) ABSTRACT

An improved attached growth trickling filter (40) includes randomly-placed textile chips (65) used as the filter medium.

### BACKGROUND AND SUMMARY OF THE INVENTION

This invention relates to wastewater treatment systems utilizing contact surfaces supporting microorganisms and improvements thereto. More particularly, this invention relates to an improved trickling filter design to treat wastewater to higher standards than previously obtainable without the need for a clarifier following the filter.

Fixed film wastewater treatment systems utilizing contact surfaces for supporting microorganisms represent the original biological mechanism for treating wastewater. Fixed film wastewater treatment systems dominated the technology of wastewater treatment for several decades and were instrumental in promoting early disease control and environmental protection. The trickling filter, first used in England in 1893 is one of the oldest wastewater treatment processes used throughout the world.

The trickling filter is an aerobic treatment process utilizing microorganisms attached to a medium to remove organic matter from wastewater that passes over, around, through, or by the medium. These types of systems are known as attached-growth processes, in contrast to systems where microorganisms are sustained in a liquid, which are known as suspended growth processes.

The first trickling filter wastewater treatment system utilized in the United States was in Madison, Wis. in 1901. Trickling filters were the most common type of wastewater treatment systems until about 1950 because of their simplicity, ease of operation, and cost effective performance capabilities. After this time, suspended growth treatment systems utilizing the activated sludge process became the most widely used type of wastewater treatment process due to an improved level of treatment capability.

Trickling filter technology was revived in the early 1970's with the development of plastic packing media. The plastic packing media allowed the filters to be operated at a much higher rate, which reduced the overall area and the cost. Since the advent of plastic media, there have been few technological improvements to the trickling filter process.

According to a United States Environmental Protection Agency (USEPA) Wastewater Technology Fact Sheet, trickling filters offer several advantages:
A simple, reliable biological process
Suitable in areas where large tracts of land are not available for land intensive treatment systems
May qualify for equivalent secondary treatment discharge standards
Effective in treating high concentrations of organics depending on the type of medium used
Appropriate for small to medium size communities
Rapidly reduces soluble BOD in applied wastewater
Efficient nitrification units
Durable process elements
Low power requirements
Moderate level of skill and technical expertise needed to manage and operate the system

According to the same USEPA fact sheet, trickling filters also have the following disadvantages:
Additional treatment may be needed to meet more stringent discharge standards
Possible accumulation of excess biomass that cannot retain an aerobic condition and can impair trickling filter performance
Requires regular operator attention
Incidence of clogging is relatively high
Requires low loadings depending on the medium
Flexibility and control are limited in comparison to the activated sludge process
Vector and odor problems
Snail problems

Accordingly, a need exists for a trickling filter design which retains the process advantages and minimizes the disadvantages.

The present invention is a trickling filter designed to provide effective treatment of wastewater. The trickling filter preferably follows a pretreatment device consisting of a clarifier, septic tank, Imhoff tank or other treatment system which provides primary treatment of the wastewater by removing settleable solids and floating materials such as fats, oils and grease.

Wastewater from the primary treatment device enters a basin for storage prior to discharge to the trickling filter. Dosing siphons or pumps in or adjacent to the basin dose the primary effluent through a conduit to a rotary distributor or fixed spray nozzle system in the trickling filter. A rotary distributor may be hydraulically powered by the dosing siphon or pumps in the storage basin or electrically powered so as to rotate the distributor arms over the filter media, dispensing the primary effluent in an even manner across the entire filter bed.

Wastewater flows by gravity through the filter bed and is treated by a combination of physical, biological and mechanical processes. The filtered effluent passes through an underdrain system, which provides support for the medium and movement of air throughout the filter bed. In a conventional trickling filter design, a clarifier follows the trickling filter to separate the treated wastewater from solids sloughed off the media.

A component in the design of the illustrated embodiment of the trickling filter of the present invention is the type of medium used. Typical trickling filters utilize a permeable medium made of a bed of rock, slag, or plastic over which wastewater is distributed to trickle through. Rock or slag beds can be up to 200 feet in diameter and three to eight feet deep with rock size varying from one to four inches in diameter. Most rock media provide about 15 square feet/cubic feet of surface area and less than 40% void space. Packed plastic bed filters are typically 20-40 feet diameter and 14 to 40 feet deep. The plastic media is available in various configurations.

Due to the nature of the rock, slag or plastic medium, a biological film or slime layer (approximately 0.1 to 0.2 mm thick) attaches to the medium. As the wastewater flows over the medium, microorganisms already in the water gradually attach themselves to the rock, slag or plastic surface and form a film. The organic material in the wastewater is then degraded by the aerobic microorganisms in the outer part of the slime layer. As the layer thickens through microbial growth, oxygen cannot penetrate the medium face, and anaerobic microorganisms develop. As the biological film continues to grow, the microorganisms near the surface lose their ability to cling to the medium, and a portion of the slime layer falls off the filter. This process is known as sloughing. The sloughed solids are carried out of the filter with the filtered effluent and are typically directed to a clarifier for removal from the wastewater.

The type of medium used in this design is a non-woven textile made from continuous or non-continuous synthetic fibers impervious to typical wastewater constituents. The synthetic fibers may be polyester, polypropylene, polyethylene, other synthetic materials, or a blend of materials. The fibers are illustratively configured into a chip of approximately two inches square and one-quarter inch thickness. The chips have a plurality of layers of material arranged in a random fashion to provide the filter medium. Illustratively, the chips are Item #05578 chips bioreactor type 4 available from Texel, Inc., located in Quebec, Canada, the specification of these chips being incorporated herein by reference. The chips are randomly placed to form a bed in the trickling filter, said bed typically being at least two feet in thickness.

The textile material has several advantages over typical trickling filter medium. The open area within the textile chip is at least 85% compared to the 40% open area of rock media. Open area is a relative measure of pore size and is the percentage of void volume within the textile material. The textile material illustratively has a water holding capacity of at least 15% by weight, which is much greater than the rock, slag or plastic media. The textile material illustratively also has a surface area of up to 5,000 square feet/cubic feet along with the large open area and water holding capacity.

One benefit of the textile material is that the media acts as both the attached growth medium for microorganism attachment and provides solids separation without the need for a separate clarifier as in conventional trickling filters. As the wastewater flows over the textile chips, microorganisms gradually attach themselves to the fibers of each chip. The organic material in the wastewater is then degraded by the aerobic microorganisms attached to the fibers. Due to the small diameter of the fibers, a thick slime layer cannot develop as occurs with rock, slag and plastic media and oxygen is present throughout the medium, preventing the growth of anaerobic microorganisms. The small diameter of the fibers allows the microorganisms to cling to the textile chips, and substantially reduces or prevents the sloughing of the biomass common in conventional trickling filters. Most of the biological activity takes place in the upper layers of the bed, and any excess biological material will be deposited in lower layers of the bed and biologically degraded in a similar fashion.

The illustrative textile material medium provides higher biochemical oxygen demand (BOD), suspended solids, and ammonia reduction than conventional trickling filters. The design of the textile media chips allows more aerobic microorganisms to populate the media bed, providing more biomass to reduce BOD and suspended solids. The water retention capabilities of the textile chips also allow a higher biological retention time and a higher nitrification rate, thereby reducing ammonia-nitrogen in the effluent.

In another embodiment of this invention, all or a portion of the treated effluent from the trickling filter may be recirculated back to the storage basin receiving effluent from the primary treatment device. This recirculated effluent will dilute the primary effluent and reduce odors as the mixture is applied to the trickling filter bed. The diluted mixture will also allow higher hydraulic loading of the trickling filter due to the reduced organic loading, and will provide greater levels of treatment by recirculating the wastewater through the trickling filter multiple times prior to disposal. Recirculation of the treated effluent back to the storage basin may also allow the trickling filter to be continually dosed during periods when there is no flow from the primary treatment device.

The illustrated embodiment of the present invention allows the continual usage of a simple, reliable biological wastewater treatment process for small and medium size communities, which is capable of meeting more stringent effluent discharge standards now being imposed by state and federal regulatory requirements. The trickling filter process, with its limited and durable mechanical components, requires much less technical expertise to operate and maintain as compared to suspended growth technologies, but with this invention can now consistently provide the same or better levels of treatment.

In an illustrated embodiment of the present invention, a clarifier is no longer needed after the trickling filter, thereby reducing the overall capital cost of the system, as well as operation, maintenance and replacement costs.

Also in an illustrated embodiment of the present invention, existing trickling filters currently in service, but in danger of being replaced by suspended growth processes in order to meet more stringent effluent discharge requirements, can be cost effectively retrofitted by replacing the existing media with textile chips. Owners of existing trickling filters can potentially reuse much of their current infrastructure, thereby saving capital costs and upgrading their facilities in much less time and with less disruption to service.

Additional features of the invention are set forth in the description that follows, and will become apparent to those skilled in the art upon reviewing the drawings in connection with the following description.

### BRIEF DESCRIPTION OF THE DRAWINGS

FIG. 1 is a plan view of an embodiment of a trickling filter wastewater treatment system according to the present invention;

FIG. 2 is an expanded plan view of a trickling filter wastewater treatment device according to the present invention;

FIG. 3 is a side view of a trickling filter wastewater treatment device according to the present invention;

FIG. 4 is a plan view of an additional embodiment of a trickling filter wastewater system according to the present invention; and

FIG. 5 is an expanded plan view of an additional embodiment of a trickling filter wastewater treatment system according to the present invention with the filter media and underdrain system not shown.

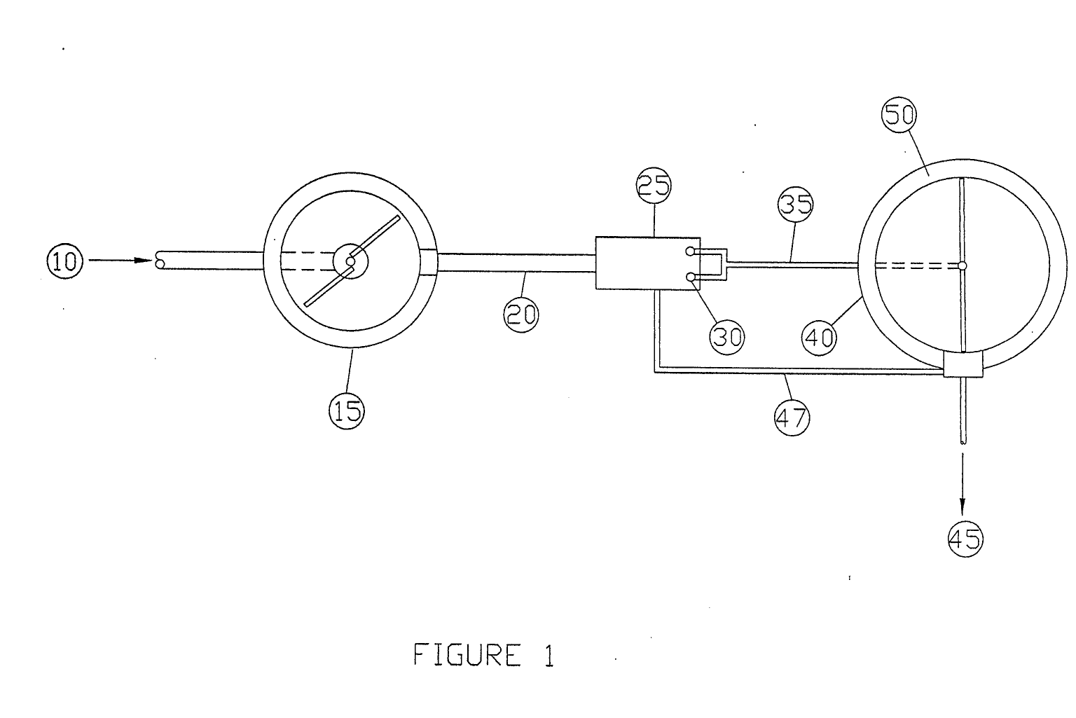

FIGS. 1-5 are not shown to scale.

### DETAILED DESCRIPTION OF DRAWINGS

FIG. 1 shows a plan view of an embodiment of a trickling filter wastewater treatment system of the present invention. Collected wastewater 10 flows into the primary treatment device 15, typically being a clarifier, septic tank, Imhoff tank, or other means of primary treatment. Settleable solids and floating materials such as fat, oil and grease are removed in the primary treatment device. Primary effluent is directed through pipe 20 to a storage basin 25. Stored effluent is periodically time discharged by dosing siphon or pumps 30 through conduit 35 to a trickling filter 40. The trickling filter is contained in a tank 50 located either above or below grade. Tank 50 may be made from steel, concrete, fiberglass or other durable materials. Treated effluent from the trickling filter is discharged through a conduit or open channel 45 for additional treatment or final disposal or reuse. Additionally, a portion or all of the trickling filter effluent may be recirculated back to the storage basin 25 through conduit 47.

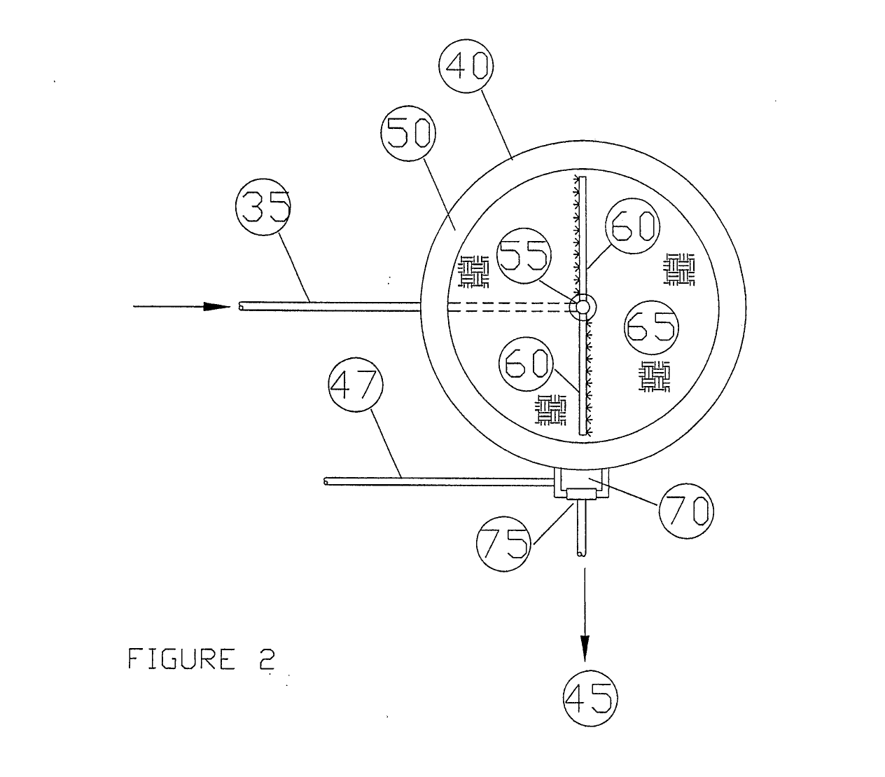

FIG. 2 shows an expanded plan view of an illustrated embodiment of a trickling filter wastewater treatment device 40. The device is contained in a tank 50 located either above or below grade. Tank 50 may be made from steel, concrete, fiberglass or other durable materials. Primary treated wastewater is time dosed from a storage basin through conduit 35 to a rotary distributor center well 55 (alternately to fixed spray nozzles located over the filter bed). Wastewater is distributed across the filter bed by distributor arms 60 extending from the distributor well 55. The distributor arms may be rotated by the hydraulic energy from the wastewater flow or alternately may be turned by a small electrical or hydraulic motor. Wastewater trickles through the textile chip media bed 65 and is collected in an outlet box 70. The collected treated wastewater is discharged through an outlet valve 75 to conduit or open channel 45 for additional treatment or final disposal or reuse. Additionally, a portion or all of the trickling filter effluent may be recirculated back to the storage basin through conduit 47.

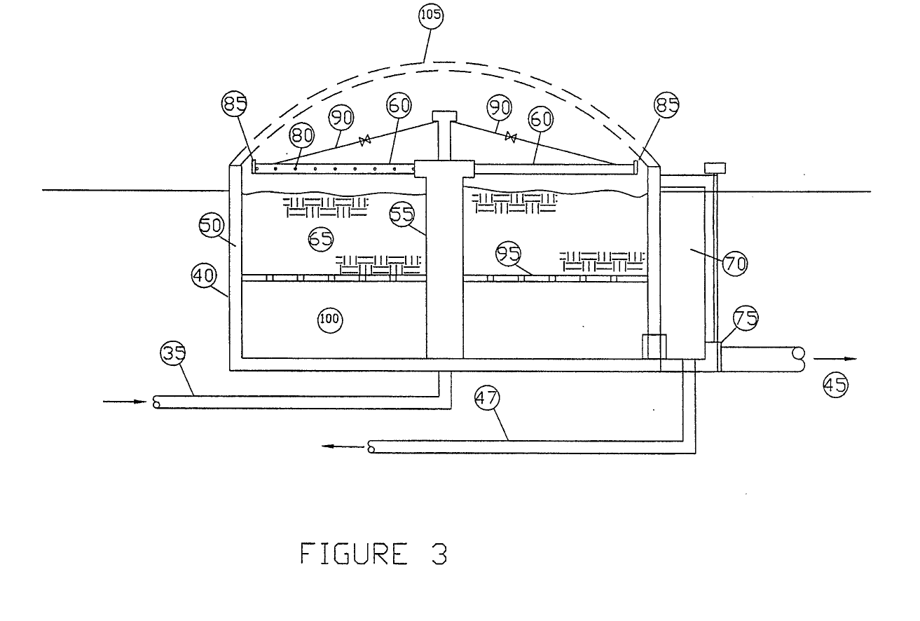

FIG. 3 is a side view of the embodiment of the trickling filter wastewater treatment device 40 shown in FIG. 2. The device is contained in a tank 50 located either above or below grade. Tank 50 may be made from steel, concrete, fiberglass or other durable materials. As discussed above, primary treated wastewater is time dosed from a storage basin through conduit 35 to a rotary distributor center well 55 (alternately to fixed spray nozzles located over the filter bed). Wastewater is distributed across the filter bed by distributor arms 60 extending from the distributor well 55, through orifices 80. An arm dump gate 85 is located at the end of the distributor arms 60 to allow the arms to be flushed and cleaned. The distributor arms 60 are typically supported by stay rods and turnbuckles 90. The distributor arms 60 may be rotated by the hydraulic energy from the wastewater flow or alternately may be turned by a small electrical or hydraulic motor. A cover 105 may be installed over the filter to reduce odors, vectors, and to retain heat in colder climates. Wastewater trickles through the textile chip media bed 65, through an underdrain support device 95 and into a storage area 100 and is collected in an outlet box 70. The collected treated wastewater is discharged through an outlet valve 75 to conduit or open channel 45 for additional treatment or final disposal or reuse. Additionally, a portion or all of the trickling filter effluent may be recirculated back to the storage basin through conduit 47.

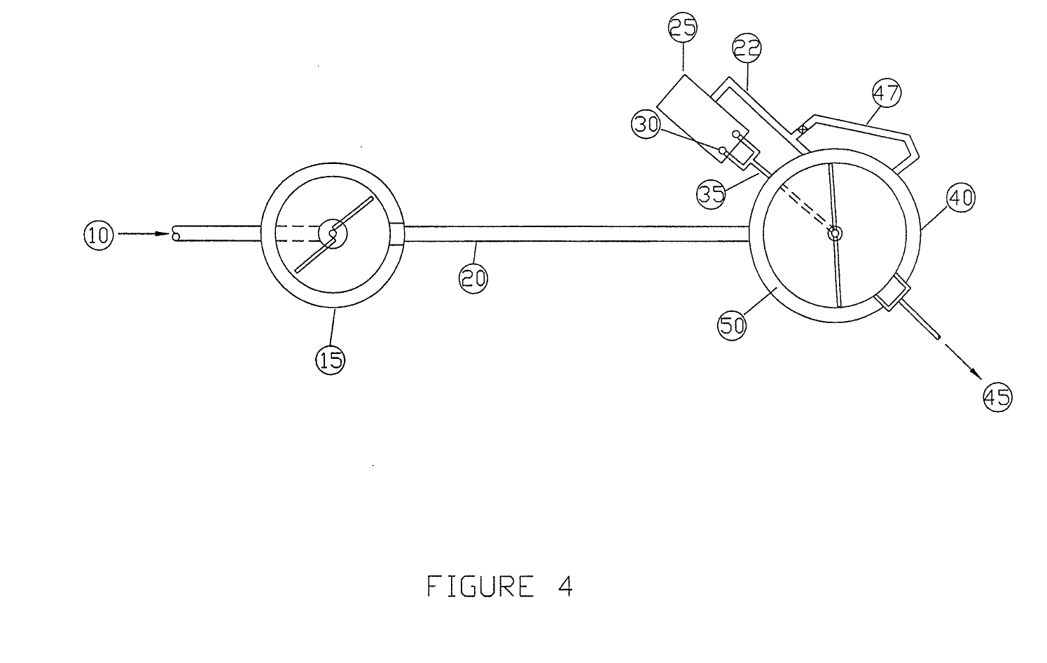

FIG. 4 is a plan view of another embodiment of the trickling filter wastewater treatment system which utilizes the area beneath the filter bed for recirculation and storage. Collected wastewater 10 flows into the primary treatment device 15, typically being a clarifier, septic tank, Imhoff tank, or other means of primary treatment. Settleable solids and floating materials such as fat, oil and grease are removed in the primary treatment device. Primary effluent is directed through pipe 20 to the trickling filter 40. The trickling filter is contained in a tank 50 located either above or below grade. Tank 50 may be made from steel, concrete, fiberglass or other durable materials. A mixture of stored primary effluent and trickling filter effluent flows from the filter through conduit 22 to a storage basin 25. The wastewater in storage basin 25 is periodically time discharged by dosing siphon or pumps 30 through conduit 35 to a trickling filter 40. Treated effluent from the trickling filter is discharged through conduit or open channel 45 for additional treatment or final disposal or reuse.

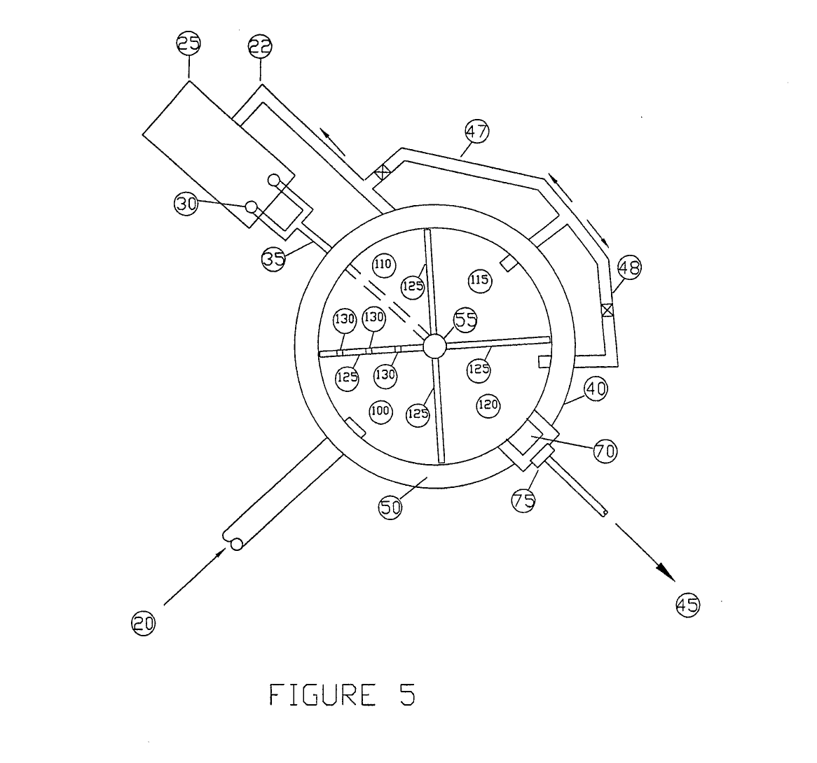

FIG. 5 shows an expanded plan view of an other embodiment of a trickling filter wastewater treatment device 40 with the media 65 and underdrain assembly 95 not shown for better illustration. The media 65 and underdrain assembly 95 used in this embodiment are illustratively shown in FIG. 3. The device is contained in a tank 50 located either above or below grade. Tank 50 may be made from steel, concrete, fiberglass or other durable materials. Primary treated wastewater flows through conduit 20 to a storage area 100 beneath the filter bed and underdrain assembly 95. Treated wastewater from the trickling filter bed located above the storage area 100 falls through the underdrain assembly 95 and mixes with the primary effluent from conduit 20 in the storage area 100. The effluent mixture flows through openings 130 in a dividing wall 125 into storage area 110. Dividing walls 125 illustratively extend from the bottom of the filter tank 50 to the bottom of the underdrain assembly 95 and provide separate watertight storage areas below the filter bed and underdrain assembly. Treated wastewater from the trickling filter bed located above storage area 110 falls through the underdrain assembly 95 and mixes with the wastewater in storage area 110. The effluent mixture in storage area 110 flows through conduit 22 to a storage basin 25 located outside or inside of filter tank 50. The wastewater in storage basin 25 is periodically time discharged by dosing siphon or pumps 30 through conduit 35 to a rotary distributor well 55 or to fixed spray nozzles for distribution across the filter bed as discussed above. Treated wastewater from the trickling filter bed located above storage area 115 falls through the underdrain assembly and mixes with the wastewater in storage area 115. The effluent mixture in storage area 115 may be directed through conduit 47 to storage basin 25 for additional recirculation volume or may be directed through conduit 48 to storage area 120. Treated wastewater from the trickling filter bed located above storage area 120 flows to outlet box 70 and is discharged through an outlet valve 75 to conduit or open channel 45 for additional treatment or final disposal or reuse.

It is understood that passive air vents may be provided at desired locations of the trickling filter 40 to keep the filter media aerobic.

While the invention set forth above and shown in the drawings is described in reference to certain illustrated embodiments, those skilled in the art will recognize that various modifications can be made to the system disclosed above without departing from the spirit and scope of the invention as set forth in the claims attached hereto.

1. A trickling filter system for wastewater treatment, the system comprising:
a primary treatment device for removing settleable solids and floating materials from the wastewater; and
a trickling filter coupled to the primary treatment device to receive effluent therefrom, the trickling filter having a filter bed including a textile filter medium.

2. The trickling filter system as recited in claim 1, wherein said medium is a non-woven textile made from at least one of continuous and non-continuous synthetic fibers impervious to wastewater constituents.

3. The trickling filter system as recited in claim 2, wherein the synthetic fibers include at least one of polyester, polypropylene, and polyethylene.

4. The trickling filter system as recited in claim 2, wherein the synthetic fibers are configured into a chip having a size of approximately two inches square and one-quarter inch thickness.

5. The trickling filter system as recited in claim 2, wherein the synthetic fibers are configured to form a plurality of filter chips which are placed in the trickling filter to form the filter bed.

6. The trickling filter system as recited in claim 5, wherein the filter bed has a thickness of at least two feet.

7. The trickling filter system as recited in claim 1, wherein said textile filter medium includes a plurality of filter textile chips, each textile chip having an open area within the textile chip of at least 85%.

8. The trickling filter system as recited in claim 1, wherein said medium has a water holding capacity of at least 15% by weight.

9. The trickling filter system as recited in claim 1, wherein said medium has a surface area of up to 5,000 square feet/cubic feet.

10. The trickling filter system as recited in claim 1, wherein the system operates without the requirement of a clarifier after the trickling filter to capture sloughed solids from the filter medium.

11. The trickling filter system as recited in claim 1, wherein at least a portion of the trickling filter effluent is recirculated back and mixed with the primary treatment device effluent prior to being discharged onto the filter bed of the trickling filter.

12. The trickling filter system as recited in claim 1, wherein the primary treatment device effluent is mixed with the trickling filter effluent within a storage basin located below the filter bed.

13. The trickling filter system as recited in claim 1, wherein the filter bed is covered with a cover.

14. The trickling filter system as recited in claim 1, wherein the trickling filter produces higher biochemical oxygen demand, total suspended solids, and ammonia-nitrogen reduction than conventional trickling filter wastewater treatment devices.

15. The trickling filter system as recited in claim 1, wherein said textile filter medium provides an attached growth medium for microorganism attachment and also provides solids separation.

16. (canceled)

17. The trickling filter system as recited in claim 1, wherein the floating materials comprise at least one of fats, oils and grease.
